(19) United States
(12) Patent Application Publication
(10) Pub. No.: US 2015/0298064 A1
(43) Pub. Date: Oct. 22, 2015

(54) SEPARATION MEMBRANE AND SEPARATION MEMBRANE ELEMENT

(71) Applicant: TORAY INDUSTRIES, INC., Tokyo (JP)

(72) Inventors: Kentaro TAKAGI, Otsu-shi (JP); Masahiro KIMURA, Otsu-shi (JP); Masakazu KOIWA, Otsu-shi (JP); Hiroyuki YAMADA, Otsu-shi (JP); Hiroho HIROSAWA, Otsu-shi (JP)

(73) Assignee: TORAY INDUSTRIES, INC., Tokyo (JP)

(21) Appl. No.: 14/409,565

(22) PCT Filed: Jul. 23, 2013
(86) PCT No.: PCT/JP2013/069852

§ 371 Date: Dec. 19, 2014

(30) Foreign Application Priority Data
Jul. 31, 2012 (JP) 2012-169409

(51) Int. Cl. B01D 69/10; C02F 1/44; B01D 69/12

(52) U.S. Cl. CPC B01D 69/10; B01D 69/12; C02F 1/44

(57) ABSTRACT

A separation membrane (31) is provided with: a separation membrane main body comprising at least a base material (11) and a separation functional layer (13) which are provided with a supply side surface (17) and a permeation side surface (18); material (11) on the side opposite to that of the separation functional layer (13) in the direction of thickness. Two or more layers of the flow path material are included. As a result, a separation membrane and separation membrane element which are effective in providing stable performance when repeated operation is carried out under conditions of high pressure over a long period of time are provided.

### TECHNICAL FIELD

The present invention relates to a separation membrane element adapted for use in separating components in a fluid such as liquid or gas.

### BACKGROUND ART

Various methods are proposed for separating components in a fluid such as liquid or gas. For example, in a technology for removing ionic substances in sea water, brackish water, or the like, in recent years, a method of separation by a separation membrane element is widely used as a process for energy conservation and natural resource saving. Separation membranes used for the method of separation by a separation membrane element are divided into a microfiltration membrane, an ultrafiltration membrane, a nanofiltration membrane, a reverse osmosis membrane, a forward osmosis membrane, and the like based on its pore diameter and a separation function. These membranes are used, for example, in the production of drinking water from sea water, brackish water, or water containing toxic substances, the production of industrial ultra-pure water, wastewater treatment or recovery of valuables. The membranes used are selected depending on the target component to be separated and the separation performance.

The separation membrane elements are common in that a raw fluid is supplied to one surface of a separation membrane and a permeate fluid is obtained from the other surface. The separation membrane element is configured such that by including many separation membranes bundled, a large membrane area is secured, and a large amount of permeate fluid can be obtained per unit separation membrane element. As the separation membrane element, various elements such as a spiral type, a hollow fiber type, a plate and frame type, a rotating flat-sheet membrane type and an integrated flat-sheet membrane type are used according to uses and purposes.

For example, a spiral separation membrane element is commonly used for reverse osmosis-filtration. The spiral separation membrane element includes a holed water collecting pipe, feed channel materials for supplying a raw fluid to the separation membrane, a separation membrane for separating components contained in the raw fluid, and permeate channel materials for guiding the permeate fluid having permeated the separation membrane to a holed water collecting pipe. The feed channel materials, the separation membrane, and the permeate channel materials are wound around the holed water collecting pipe. Since the spiral separation membrane element can provide pressure for the raw fluid to draw out a large amount of the permeate fluid, it is widely used.

### PRIOR ART DOCUMENTS

### Patent Documents

In recent years, needs for cost-reduction of a separation membrane element are increasing because of increasing requirement for reducing the cost of water production by the separation membrane element, and measures to reduce cost by improvements of a separation membrane, a channel member and a separation membrane element member are proposed, and for example, in Patent Documents 1 and 2, dot-shaped or stripe-shaped channel materials are disposed on the surface or backside of a flat membrane in a spiral separation membrane element.

Patent Document 1: International Publication WO 2011/152484

Patent Document 2: Japanese Patent Laid-open Publication No. 2012-40487

### SUMMARY OF THE INVENTION

### Problems to be Solved by the Invention

In the technologies disclosed in Patent Documents 1 and 2, stable performance at the time when a repeated operation is conducted for an extended period is not enough.

Accordingly, it is an object of the present invention to form a flow path on the permeate side which is highly efficient and stable, and to present a separation membrane element which exhibits stable performance even in repeated operations and an operation under conditions of high pressure for an extended period.

### Solutions to the Problems

In order to solve the above-mentioned problem, the separation membrane of the present invention has the following constitution. That is,

a separation membrane comprising: a separation membrane main body having a feed side surface and a permeate side surface, and a channel material affixed to the permeate side surface of the separation membrane main body, wherein the channel material includes two or more layers.

Further, the separation membrane element of the present invention has the following constitution. That is, a separation membrane element including the above-mentioned separation membrane.

In the separation membrane of the present invention, the respective layers of the channel material are preferably bonded to one another.

The separation membrane of the present invention is preferably affixed to the separation membrane main body with adhesive force of 1 N/m or more.

The separation membrane of the present invention has an adhesion layer to be bonded to the separation membrane main body, and a highly elastic layer laminated on the adhesion layer, and the compressive elasticity modulus of the highly elastic layer is preferably 0.1 GPa or more and 5.0 GPa or less.

In the separation membrane of the present invention, the channel material is preferably formed of a thermoplastic resin.

In the separation membrane of the present invention, the separation membrane preferably comprises a base material; a porous support layer formed on the base material; and a separation functional layer formed on the porous support layer.

In the separation membrane of the present invention, the base material is preferably a continuous fiber nonwoven fabric.

The separation membrane is preferably applied to a spiral separation membrane element.

### Effects of the Invention

In accordance with the present invention, it is possible to form a flow path on the permeate side which is highly efficient and stable and to obtain a separation membrane element which exhibits stable performance even in repeated operations and an operation under conditions of high pressure.

### BRIEF DESCRIPTION OF THE DRAWINGS

FIG. 1 is a partially developed perspective view showing a scheme of a separation membrane element.

FIG. 2 is a sectional view showing an example of a separation membrane including permeate channel materials.

FIG. 3 is a sectional view showing another example of a separation membrane including permeate channel materials.

FIG. 4 is a sectional view showing an example of a separation membrane main body.

FIG. 5 is a sectional view showing another example of a separation membrane main body.

FIG. 6 is a plan view showing an example of a separation membrane including permeate channel materials.

FIG. 7 is a plan view showing another example of a separation membrane including permeate channel materials.

FIG. 8 is a plan view showing further example of a separation membrane including permeate channel materials.

FIG. 9 is a plan view showing further example of a separation membrane including permeate channel materials.

FIG. 10 is a plan view showing further example of a separation membrane including permeate channel materials.

FIG. 11 is a sectional view of the separation membrane taken on a dashed line indicated by arrows A in FIG. 6.

FIG. 12 is a sectional view of the separation membrane taken on a dashed line indicated by arrows A in FIG. 8.

FIG. 13 is a sectional view of the separation membrane taken on a dashed line indicated by arrows A in FIG. 9.

FIG. 14 is a sectional view showing another embodiment of a permeate channel material.

FIG. 15 is a sectional view showing further embodiment of a permeate channel material.

### EMBODIMENTS OF THE INVENTION

Hereinafter, an embodiment of the present invention will be described.

### [1. Separation Membrane Element]

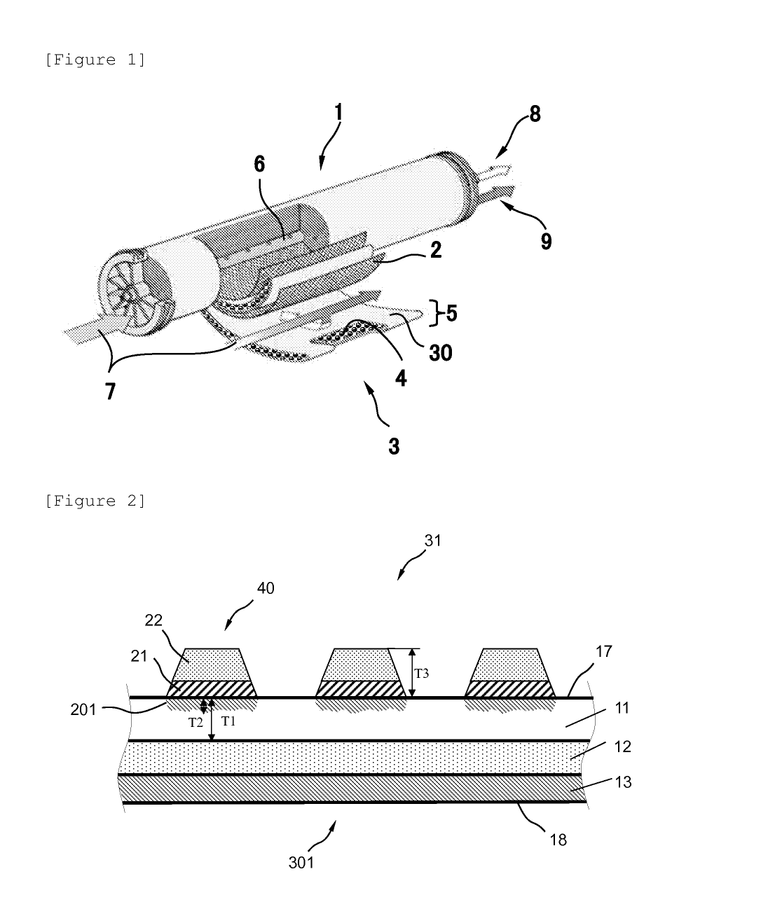

As shown in FIG. 1, the separation membrane element 1 includes a water collecting pipe 6, and a separation membrane 3 wound around the water collecting pipe 6. Further, the separation membrane element further includes members such as feed channel materials 2, and end plate.

The separation membrane 3 includes a separation membrane main body 30 and permeate channel materials 4 arranged on a permeate side surface of the separation membrane main body 30.

The separation membrane 3 forms a rectangular envelope-like membrane 5 whose permeate side surface is directed inwardly. The envelope-like membrane 5 is opened at only one side of the envelope-like membrane, and sealed at other three sides in order to flow the permeate water into the water collecting pipe 6. The permeate water is isolated from feed water by the envelope-like membrane.

The feed channel materials 2 are disposed between the envelope-like membrane 5, that is, between the feed side surfaces of the separation membrane. The feed channel materials 2 and a plurality of the envelope-like membranes 5 are wound in a state of being overlaid around the water collecting pipe 6.

The raw water (indicated as “feed water 7” in the drawing), which is supplied from one end in a longitudinal direction of the separation membrane element 1, passes through a flow path formed by the feed channel materials 2 and supplied to the separation membrane main body 30.

Water which has passed through the separation membrane main body 30 (indicated as “permeate water 8” in the drawing) passes through a flow path formed by the permeate channel materials 4 and flows into the water collecting pipe 6. Thus, the permeate water 8 is recovered from one end of the water collecting pipe 6.

On the other hand, water which has not passed through the separation membrane main body 30 (indicated as “concentrated water 9” in the drawing) is recovered from the other end of the separation membrane element 1.

The separation membrane element 1 shown in FIG. 1 is an example of a constitution of the spiral separation membrane element including a water collecting pipe, and a separation membrane wound around the water collecting pipe, and the present invention is not limited to this morphology.

### [2. Separation Membrane]

As the separation membrane 3 used for the above-mentioned separation membrane element, various morphologies of separation membranes described below can be applied. In reference to drawings, the various morphologies will be described; however, in the following descriptions, sometimes, constituent elements described in reference to another drawing are denoted by like reference signs, and descriptions thereof are omitted.

### (2-1) Overview

A separation membrane is a membrane which can separate components in fluid supplied to the surface of the separation membrane to obtain permeate fluid having permeated the separation membrane. The separation membrane includes a separation membrane main body and a channel material arranged on the separation membrane main body.

An example of such a separation membrane is shown in FIG. 2. As shown in FIG. 2, the separation membrane 31 includes a separation membrane main body 301 and a permeate channel material 40. The separation membrane main body 301 includes a feed side surface 17 and a permeate side surface 18.

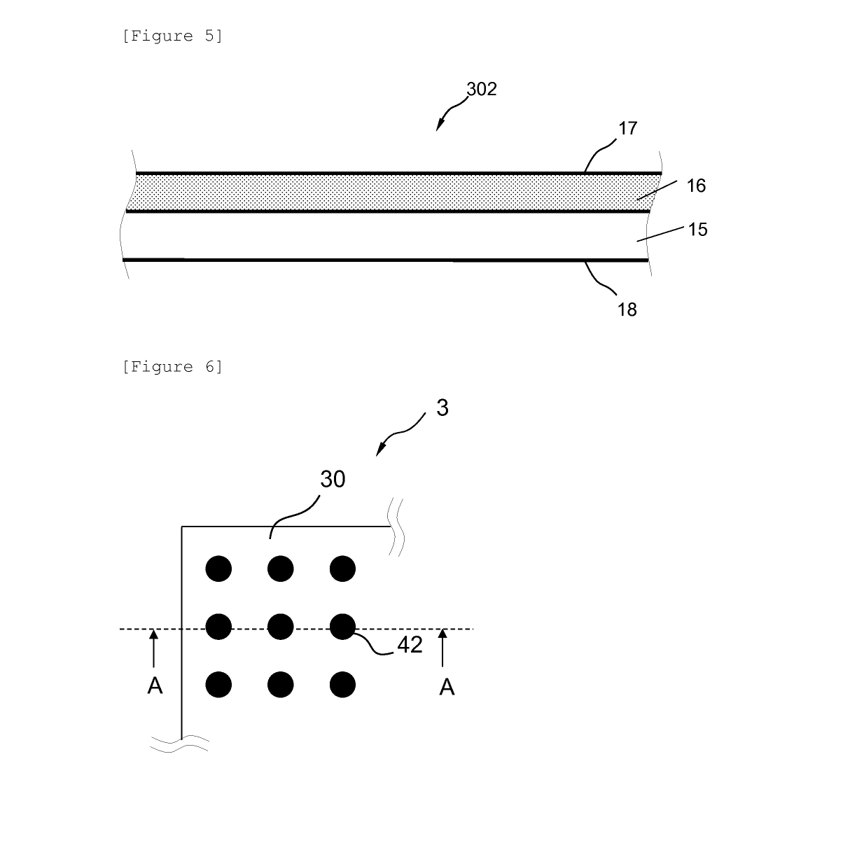

In the present specification, the “feed side surface” of the separation membrane main body means a surface on the side to which raw fluid is supplied, of two surfaces of the separation membrane main body. The “permeate side surface” means a surface opposite to the feed side surface. When the separation membrane main body includes a base material (11, 15) and a separation functional layer (13, 16) as shown in FIG. 4 and FIG. 5, in general, the surface on a separation functional layer side is the feed side surface, and the surface on a base material side is the permeate side surface.

### (2-2) Separation Membrane Main Body

### <Overview>

As the separation membrane main body 30, a membrane having separation performance according to usage, an intended use or the like is used. The separation membrane main body 30 may be formed of a simple layer, or may be a composite membrane including a base material and a separation functional layer.

Examples of the composite membrane are shown in FIG. 4 and FIG. 5. The separation membrane main body 301 shown in FIG. 4 includes a base material 11, a porous support layer 12 and a separation functional layer 13. On the other hand, a separation membrane main body 302 shown in FIG. 5 is composed of two layers of a base material 15 and a separation functional layer 16. Hereinafter, each layer will be described.

### <Separation Functional Layer>

The thickness of the separation functional layer is not limited to a specific value; however, it is preferably 5 nm or more and 3000 nm or less in view of the separation performance and the permeation performance. Particularly in the case of the reverse osmosis membrane, the forward osmosis membrane, and the nanofiltration membrane, the thickness is preferably 5 nm or more and 300 nm or less.

The thickness of the separation functional layer may be measured in accordance with a conventional method of measuring the thickness of the separation membrane. For example, an ultrathin section is prepared by embedding the separation membrane in a resin and slicing from the embedded membrane, and the resulting thin section is subjected to the staining or other necessary treatment. Thereafter, the section is observed with a transmission electron microscope, and thereby, the thickness can be measured. Further, when the separation functional layer has a protuberance structure, the thickness can be determined by measuring the thickness in the longitudinal cross-sectional direction of the protuberance structure for 20 protuberances present above the porous support layer at an interval of 50 nm, and calculating the average of the 20 measurements.

The separation functional layer may be a layer having both of a function of separation and a function of support, or may have only the function of separation. Here, the “separation functional layer” refers to a layer having at least the function of separation.

When the separation functional layer has both of the function of separation and the function of support (e.g., an aspect shown in FIG. 5), a layer containing, as a main component, cellulose, polyvinylidene fluoride, polyether sulfone or polysulfone is preferably applied as the separation functional layer.

In the present specification, the phrase “X contains Y as a main component” means that the content of the Y in the X is 50% by mass or more, 70% by mass or more, 80% by mass or more, 90% by mass or more, or 95% by mass or more. When a plurality of components corresponding to the Y are present, the total amount of the plurality of components may satisfy the range described above.

On the other hand, when the separation functional layer is disposed as a separate layer from the porous support layer (e.g., an aspect shown in FIG. 4), a crosslinked polymer is preferably used as a material constituting the porous support layer in view of ease of the control of the pore size and excellent durability. Particularly, in view of the excellent separation performance of components in the raw fluid, a polyamide separation functional layer prepared by polycondensation of a polyfunctional amine and a polyfunctional acid halide, an organic-inorganic hybrid functional layer, or the like is suitably used. These separation functional layers can be formed by polycondensation of monomers on the porous support layer.

For example, the separation functional layer may contain polyamide as a main component. Such a membrane is formed by interfacial polycondensation of a polyfunctional amine and a polyfunctional acid halide according to a publicly known method. For example, a polyfunctional amine aqueous solution is applied onto the porous support layer, and the excessive amine aqueous solution is removed with an air knife or the like. Thereafter, an organic solvent solution containing a polyfunctional acid halide is applied to obtain a polyamide separation functional layer.

Further, the separation functional layer may have an organic-inorganic hybrid structure containing a Si element or the like. The separation functional layer having the organic-inorganic hybrid structure can contain, for example, the following compounds (A) and (B):

(A) a silicon compound having a reactive group containing an ethylenic unsaturated group and a hydrolyzable group directly bonded to the silicon atom, and

(B) a compound having an ethylenic unsaturated group other than the silicon compound (A) as described above.

Specifically, the separation functional layer may contain a condensate of the hydrolyzable group of the compound (A) and a polymerization product of the ethylenic unsaturated group of the compound (A) and/or the compound (B). That is, the separation functional layer may contain at least one polymerization product of:
a polymerization product formed by condensation and/or polymerization of only the compound (A);
a polymerization product formed by polymerization of only the compound (B); and
a copolymer of the compound (A) and the compound (B).

Here, the polymerization product includes a condensate. Further, the compound (A) may be condensed through a hydrolyzable group in the copolymer of the compound (A) and the compound (B).

The hybrid structure can be formed by a publicly known method. An example of the method of forming the hybrid structure is as follows. A reaction liquid containing the compound (A) and the compound (B) is applied onto the porous support layer. After the excessive reaction liquid is removed, heating treatment may be performed in order to condense the hydrolyzable group. Heat treatment and irradiation with an electromagnetic wave, electron beams or plasma may be employed for a polymerization method of the ethylenic unsaturated group of the compound (A) and that of the compound (B). In the formation of the separation functional layer, a polymerization initiator, a polymerization accelerator, or the like may be added for the purpose of increasing the polymerization rate.

In addition, a membrane surface of any separation functional layer may be hydrophilized, for example, with an aqueous solution containing alcohol or an alkali aqueous solution before use.

### <Porous Support Layer>

The following constitution can be applied to a separation functional layer (FIG. 5) in the case where the separation function and the support function are realized in one layer, and a porous support layer (FIG. 4) in the case where the separation function and the support function are realized in separate layers.

A material used for the porous support layer and a shape of the porous support layer are not particularly limited, and for example, the layer may be formed on the substrate by use of a porous resin. As the porous support layer, polysulfone, cellulose acetate, polyvinyl chloride, epoxy resin, or a mixture or a laminate thereof are used, and use of polysulfone is preferable in consideration of the high chemical, mechanical, and thermal stability and ease of controlling the pore size.

The porous support layer provides mechanical strength for the separation membrane and it does not have the separation performance for the component with a small molecular size such as ions as in the case of the separation membrane. The pore size and pore distribution of the porous support layer are not particularly limited, and for example, the porous support layer may have uniform fine pores, or may have pore size distribution in which the pore size gradually increases from the surface on which the separation functional layer is formed to the other surface. Further, in any of these cases, a projection area diameter of the fine pore measured at the surface on which the separation functional layer is formed, by using an atomic force microscope, an electron microscope or the like, is preferably 1 nm or more and 100 nm or less. Particularly, it is preferred that the pore at the surface on which the separation functional layer is formed in the porous support layer has a projection area diameter of 3 nm or more and 50 nm or less in view of the reactivity in the interfacial polymerization and retention of the separation functional layer.

The thickness of the porous support layer is not particularly limited, but it is preferably in the range of 20 μm or more and 500 μm or less, and more preferably 30 μm or more and 300 μm or less for providing strength for the separation membrane, or other purpose.

The morphology of the porous support layer can be observed by using a scanning electron microscope, a transmission electron microscope or an atomic force microscope. For example, when the porous support layer is observed by using a scanning electron microscope, the observation may be conducted by peeling off the porous support layer from the base material, and preparing a sample for observing the cross-section by cutting the porous support layer by a freeze-fracture method. This sample is thinly coated with platinum or platinum-palladium or ruthenium tetrachloride, preferably ruthenium tetrachloride, and observed at an acceleration voltage of 3 kV to 6 kV by using a high-resolution field-emission scanning electron microscope (UHR-FE-SEM). As the high-resolution field-emission scanning electron microscope, for example, Model S-900 electron microscope manufactured by HITACHI, LTD. can be employed. The layer thickness of the porous support layer and the projection area diameter on the surface can be measured by using the resulting electron micrograph.

The thickness and the pore size of the porous support layer are average values, and the thickness of the porous support layer is the average of 20 points obtained by observing the cross-section, and measuring 20 points at an interval of 20 μm in the direction perpendicular to the thickness direction of the membrane. The pore size is an average value of the projection area diameters obtained by measuring 200 holes.

Next, a method of forming the porous support layer will be described. The porous support layer can be produced, for example, by casting a solution of the polysulfone in N,N-dimethylformamide (hereinafter referred to as DMF) to a predetermined thickness on the base material as described later, for example, a densely woven polyester or polyester nonwoven fabric, and then coagulating the cast solution in water by wet coagulation.

The porous support layer is formed according to the method described in “Office of Saline Water, Research and Development Progress Report”, No. 359 (1968). In addition, in order to obtain the desired morphology, the polymer concentration, the solvent temperature, and the poor solvent can be adjusted.

For example, a predetermined amount of polysulfone is dissolved in DMF to prepare a polysulfone resin solution having a predetermined concentration. Then, the polysulfone resin solution is applied onto the base material made of the polyester fabric or nonwoven fabric at a substantially constant thickness, and after leaving the base material for a predetermined period in the atmosphere to remove the solvent on the surface, the polysulfone is coagulated in the coagulation solution, and thereby, the porous support layer can be obtained.

### <Base Material>

As the base material, a fibrous base material is preferably used in view of strength, provision of unevenness and fluid permeability. Both of a continuous fiber nonwoven fabric and a chopped fiber nonwoven fabric can be preferably employed as the fibrous base material. Particularly, since the continuous fiber nonwoven fabric has an excellent membrane-forming property, it can suppress the possibility that when a solution of a high molecular weigh polymer is cast, the solution permeates to a backside due to overpermeation, that the porous support layer is peeled off, that the membrane becomes non-uniform due to fuzz of the base material, and that a defect such as a pinhole is produced. Further, when the base material is made of the continuous fiber nonwoven fabric composed of thermoplastic continuous filaments, it can suppress the possibility that the membrane becomes non-uniform due to fuzz of the fibers in casting a solution of a high molecular weight compound, and a membrane defect is generated in comparison with the chopped fiber nonwoven fabric. Furthermore, since a tensile force is applied to a direction of membrane forming of the separation membrane when the separation membrane is continuously formed, it is preferred to use the continuous fiber nonwoven fabric having excellent dimension stability as the base material.

In the continuous fiber nonwoven fabric, it is preferred in point of formability and strength that fibers at the surface layer opposite to the porous support layer-side surface layer are more vertically oriented than those at the porous support layer-side surface layer. When such a structure is employed, it is preferred because the high effect of preventing membrane break, etc. is realized by maintaining strength, formability of a laminate including a porous support layer and a base material at the time of providing the unevenness for the separation membrane is improved, and the unevenness structure at the separation membrane surface becomes stable.

More specifically, the fiber orientation degree of the continuous fiber nonwoven fabric at the surface layer opposite to the porous support layer-side surface layer is preferably 0° or more and 25° or less, and the difference between this fiber orientation degree and a fiber orientation degree at the porous support layer-side surface layer is preferably 10° or more and 90° or less.

The production step of the separation membrane or the production step of the element includes a heating step, and a phenomenon occurs in which the porous support layer or the separation functional layer is shrunk by heating. The shrink is significant particularly in a width direction for which the tensile force is not provided in the continuous membrane forming. When the membrane is shrunk, since a problem of dimension stability or the like arises, a base material having a small thermal change rate of dimension is desired. When the difference between the fiber orientation degree at the surface layer opposite to the porous support layer-side surface layer and the fiber orientation degree at the porous support layer-side surface layer is 10° or more and 90° or less in the nonwoven fabric, it is preferred since changes in a width direction due to heat can also be prevented.

Herein, the fiber orientation degree is an index of orientation of fibers of a nonwoven fabric base material constituting the porous support layer. Specifically, the fiber orientation degree is an average value of angles between a membrane-forming direction in continuously producing a membrane, i.e. a longitudinal direction of the nonwoven fabric base material, and a longitudinal direction of the fibers constituting the nonwoven fabric base material. That is, when the longitudinal direction of the fiber is parallel to the membrane-forming direction, the fiber orientation degree is 0°. When the longitudinal direction of the fiber is perpendicular to the membrane-forming direction, that is, parallel to a width direction of the nonwoven fabric base material, the fiber orientation degree is 90°. Therefore, it is shown that the closer to 0° the fiber orientation degree is, the more the fibers are vertically oriented, and the closer to 90° the fiber orientation degree is, the more the fibers are horizontally oriented.

The fiber orientation degree is measured as follows. First, 10 small samples are taken at random from a nonwoven fabric. Then, the surface of the sample is photographed at a magnification of 100 times to 1000 times by using a scanning electron microscope. Ten fibers per sample are selected in the photographed image, and the angles of the fibers at the time when the longitudinal direction (vertical direction, membrane-forming direction) of the nonwoven fabric is taken as 0° are measured. That is, angles of 100 fibers per nonwoven fabric are measured. An average value is calculated from the angles of 100 fibers measured in this way. A value obtained by rounding the resulting average value to the closest whole number is the fiber orientation degree.

The thickness of the base material is preferably set to such a level at which the total thickness of the base material and the porous support layer falls within the range of 30 μm or more and 300 μm or less, or the range of 50 μm or more and 250 μm or less.

### (2-3) Permeate Channel Material

Permeate channel materials (hereinafter, sometimes referred to as merely a “channel material”) are disposed on the permeate side surface of the separation membrane main body so as to form a flow path on the permeate side. The phrase “disposed so as to form a flow path on the permeate side” means that when the separation membrane is incorporated into a separation membrane element described later, a channel material is formed in such a way that permeate fluid having permeated the separation membrane main body can reach a water collecting pipe.

The permeate channel material includes two or more layers. The phrase “permeate channel material includes two or more layers” means that at least two types of materials having different composition are superimposed on each other in the channel material. Further, the phrase “having different composition” means that chemical composition is different from each other, and, for example, the phrase subsumes a state in which at least part of contained components is different, and the contents of the contained components are different even when the contained components are the same.

In addition, a definite boundary may be existent between these layers, or may be nonexistent between these layers. Even in the case where the definite boundary is nonexistent, the case where the respective layers have different composition satisfies the condition of “permeate channel material includes two or more layers”.

As shown in FIG. 2, a layer 21 closest to the feed side surface of the separation membrane main body of layers included in a channel material 40 functions as an adhesion layer by which a layer 22 thereon is bonded to the separation membrane main body. The channel material is affixed to the separation membrane main body by the adhesion layer 21.

An uneven portion of the base material being an adherend is impregnated with the adhesion layer, and the adhesion layer is cured to act as an anchor (anchor effect), or the adhesion layer can exert an elastically-tightening force (fastener effect) by penetration of a projected portion of the adhesion layer into a depressed portion of the adherend (base material).

The adhesive force between the channel material and the base material is preferably 1 N/m or more, and more preferably 10 N/m or more. The adhesive force in this range can suppress peeling of the channel material from the base material when stress is applied to the channel material, for example, in handling a separation membrane such as production of a separation membrane element, and in operating the separation membrane element repeatedly under high pressure for an extended period.

The adhesive force between the base material and the channel material can be measured by a method established according to JIS Z 0237 (Testing methods of pressure-sensitive adhesive tapes and sheets) and JIS K 6854-3 (T-peel test). A specific procedure of the measurement method will be described in Examples.

In addition, when the channel material is peeled off from the base material in measurement of the adhesive force, part of the base material may be peeled off in association with the channel material. Even if the base material is peeled off in this way, the value of the adhesive force measured at that time is considered as an adhesive force.

The composition of the adhesion layer 21 is not particularly limited, and as the composition, an ethylene-vinyl acetate copolymer resin; polyolefins such as Polyethylene and polypropylene and copolymerization polyolefins; polyesters; urethanes; and polymers such as an epoxy are preferred in view of adhesiveness and chemical resistance. As the material of the adhesion layer, a thermoplastic resin is preferably employed in view of ease of formation of the channel material; however, a polymer which has a heat-curing property or a photo-curing property can also be applied. Further, it is possible to further enhance a joining property of the channel material to the base material by increasing surface free energy of a melt resin serving as a channel material by adding a tackifier, a natural wax and a synthetic wax (viscosity adjustor), and various additives to the above-mentioned resin. The resin and the additive can be used singly or as a mixture composed of two or more thereof.

In order to realize an adhesive property, a melt viscosity of a material constituting the adhesion layer 21 is preferably in the range of 200 to 3000 mPa·s, and more preferably 400 to 1500 mPa·s under the condition of 180° C. The melt viscosity can be measured by a method according to, for example, JIS K 6862. Further, as an example of specific composition for adjusting the melt viscosity in the above-mentioned range, the material constituting the adhesion layer preferably contains 20 to 95% by weight of a resin, 2 to 60% by weight of a tackifier, 2 to 30% by weight of wax, and 5% by weight or less of an additive. The compositional ratio of the material constituting the adhesion layer is not limited to this.

As shown in FIG. 2, the separation membrane main body, more specifically, the base material, may be impregnated with components of the adhesion layer 21. When the channel materials are arranged on a base-material side or a permeate side of the separation membrane and the separation membrane is heated from the base-material side by using a hot-melt method or the like, channel material impregnation is expanded from a backside to a front side of the separation membrane. Adhesion between the channel material and the base material becomes firm as the impregnation proceeds, and therefore the channel material is hardly peeled from the base material even when pressurized filtration is carried out. A portion impregnated with channel material components in the base material is shown as an impregnated portion with a reference numeral 201 in FIG. 2.

In addition, the term “impregnation” in the present invention refers to a state in which the channel material permeates the base material. Specifically, the term “impregnation” refers to a state in which the channel material permeates between fibers of the base material when the base material is formed of a fibrous material.

However, when the separation membrane is impregnated with the channel material components up to the vicinity of the separation functional layer, the impregnated channel material destructs the separation functional layer in pressurized filtration. Therefore, the proportion of the thickness T2 of impregnation to the thickness of the base material (i.e., the ratio of impregnation) is preferably in the range of 5% or more and 95% or less, more preferably 10% or more and 80% or less, and even more preferably 20% or more and 60% or less when the base material is impregnated with the channel material components. The thickness T2 of impregnation refers to a maximum thickness T2 of the channel material-impregnated portion, and the maximum thickness T2 of the channel material-impregnated portion means the maximum thickness of the impregnated portion 201 corresponding to the channel material in a cross-section.

The thickness T2 of impregnation of the channel material can be adjusted by changing, for example, the type of the material (more specifically, the type of a resin) constituting the channel material and/or the amount of the material. Further, when the channel materials are disposed by hot-melt method, the thickness 12 of impregnation can also be adjusted by changing the treatment temperature, etc.

In addition, it is possible to verify that the base material is impregnated with the channel-material component when a peak resulting from a component of the channel material can be detected separately from that of the base material in thermal analysis by subjecting the base material including the impregnated portion 201 to thermal analysis such as differential scanning calorimetry.

The ratio of the base material impregnated with the channel material can be determined by observing a cross-section of the separation membrane where the channel material is present by using a scanning electron microscope, a transmission electron microscope or an atomic force microscope, and calculating the thickness 12 of a channel material-impregnated portion and the thickness T1 of the base material. For example, when the thickness is observed by using a scanning electron microscope, the separation membrane is cut in a depth direction together with the channel material, a cross-section is observed by using the scanning electron microscope, and the thickness 12 of the channel material-impregnated portion and the thickness T1 of the base material are measured. The ratio of the base material impregnated with the channel material can be calculated from the ratio of the maximum thickness T2 of the channel material-impregnated portion in which the base material is impregnated to the deepest location with the channel material to the thickness T1 of the base material. In addition, the term “thickness T1 of the base material” in determining the thickness T2 of impregnation refers to the thickness of the base material at the same location as in measurement of the maximum thickness T2 of impregnation. In FIG. 2, for convenience of explanation, an arrow indicating the thickness T1 of the base material is shown so as to be displaced from an arrow indicating the maximum thickness T2 of impregnation.

The adhesion layer 21 is joined to the layer 22 disposed thereon. That is, the two layers are unified by adhesion between the layer 21 and the layer 22. It is preferred that all layers are unified in this way in the channel material. When all layers are unified, it is possible to suppress a reduction of performance resulting from displacement of the channel material in winding the separation membrane or in operating the separation membrane element.

The layer 22 preferably has a compressive elasticity modulus higher than that of the adhesion layer 21. Particularly, the compressive elasticity modulus of the layer 22 is preferably 0.1 GPa or more and 5.0 GPa or less. In the seawater desalination, an operation is conducted under high-pressure. Under high-pressure, since the channel material is compacted to narrow the flow path on the permeate side, the flow resistance is increased and the rate of water production is likely to be reduced. When the compressive elasticity modulus of the channel material is 0.1 GPa or more, such a reduction of the rate of water production can be suppressed. Further, when the compressive elasticity modulus of the channel material is extremely high, the channel material is easily broken when the separation membrane is wound. In contrast, when the compressive elasticity modulus of the channel material is 5.0 GPa or less, the breaking of the channel material can be suppressed, and the flow path can be formed stably.

The compressive elasticity modulus of the channel material can be determined by a slope of a linear portion of a stress-strain curve in a stress range in which the channel material is elastically deformed.

The composition of the layer 22 is not particularly limited, and components constituting the channel material are not particularly limited, and a resin is preferably used. Specifically, an ethylene-vinyl acetate copolymer resin, polyolefins such as polyethylene and polypropylene, and copolymerization polyolefins are preferable in view of chemical resistance. Also, polymers such as a urethane resin, an epoxy resin, and the like can be applied. These resins are used singly or as a mixture composed of two or more thereof. Particularly, thermoplastic resins have an advantage that a channel material having a uniform shape can be formed since it is easily shaped.

As a material for forming the layer 22, a composite material containing the above-mentioned resin as a matrix and further containing a filler can also be applied. The compressive elasticity modulus of the channel material can be enhanced by adding a filler such as porous inorganic substances or the like to the matrix. Specifically, silicate salts of alkaline-earth metals such as sodium silicate, calcium silicate and magnesium silicate; metal oxides such as silica, alumina and titanium oxide; and carbonate salts of alkaline-earth metals such as calcium carbonate and magnesium carbonate can be used as the filler.

Further, as with the channel material constituting the adhesion layer, a tackifier, a natural wax and/or a synthetic wax (viscosity adjustor), an antioxidant and other additives may be mixed in the above-mentioned resin. Additive amounts of the filler, the tackifier, the waxes, the antioxidant and others are not particularly limited as long as the effect of the present invention is not impaired. The above-mentioned resin, filler, and various additives may be used singly or as a mixture composed of two or more thereof.

Further, the highly elastic layer satisfying the compressive elasticity modulus in the above-mentioned range is preferably specifically made of a material containing 40 to 100% by weight of a resin, 0 to 50% by weight of a tackifier, 0 to 30% by weight of a wax, 0 to 50% by weight of a filler and 5% by weight or less of an additive.

In addition, a two-layer structure shown in FIG. 2 is an example of a constitution of the channel material including the adhesion layer to be bonded to the separation membrane main body, and the highly elastic layer laminated on the adhesion layer and having a high compressive elasticity modulus, and “lamination” includes not only a state in which two layers are in contact with each other, but also a state in which two layers overlay each other with other layer interposed therebetween.

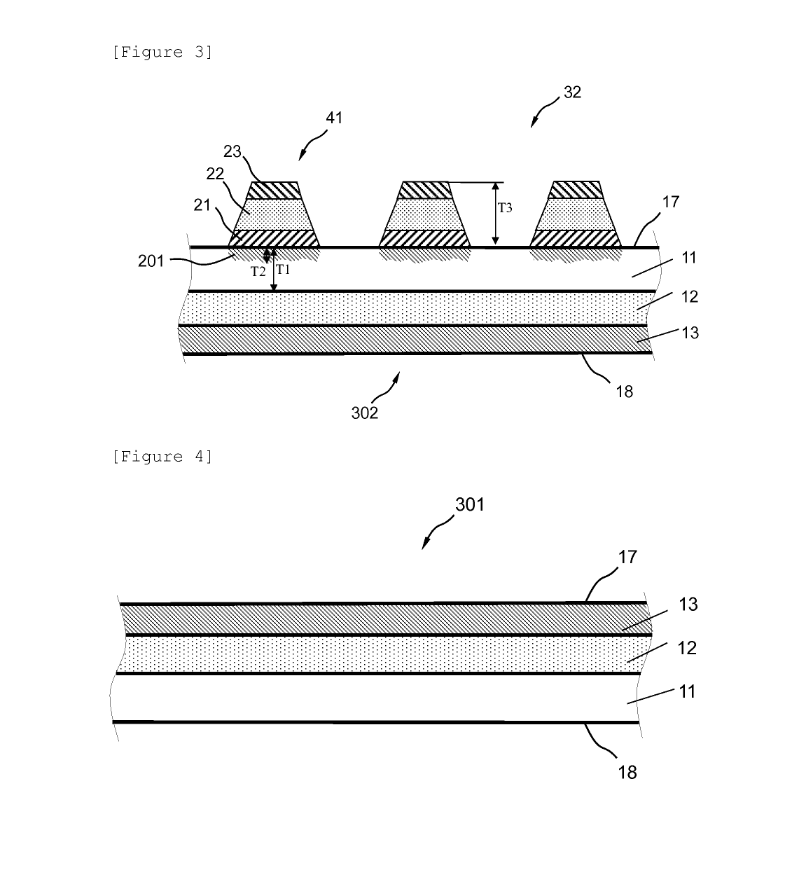

As an example, a separation membrane 32 including channel materials 41 of a three-layer structure is shown in FIG. 3. The channel material 41 includes an adhesion layer 21, and a layer 22 and a layer 23 are overlaid on the adhesion layer 21 in turns. In the example shown in FIG. 3, at least one of compressive elasticity moduli of the layer 22 and the layer 23 may satisfy the above-mentioned range.

In addition, in FIG. 2 and FIG. 3, only the adhesion layer 21 is located next to the permeate side surface 18 of the separation membrane main body; however, other one or more layers may be located next to the base material. For example, as shown in FIG. 14, the layer 22 may be located next to the permeate side surface 18. Further, as shown in FIG. 15, the layer 23 may be located next to the permeate side surface 18. Further, although not shown, both of the layer 22 and the layer 23 may be located next to the permeate side surface 18.

In addition, the thickness of each layer can be varied in such a way that the thickness T3 of the channel material, which is the total value of the thickness of each layer, satisfies a preferred range described later. In any morphology, the thickness of the highly elastic layer is preferably larger than that of the adhesion layer. By this constitution, the effect of the highly elastic layer is more exerted.

In addition, a configuration, a size and a material of the permeate channel material are not limited to a specific constitution, and these may be configured such that the permeate fluid can reach a holed water collecting pipe.

The permeate channel material has the composition different from that of the separation membrane main body. The phrase “has the composition different from that of the separation membrane” means that when the separation membrane includes a structure of three layers of a separation functional layer, a porous support layer and a base material, the composition of the channel material is different from any composition of the three layers. Further, the phrase “having different composition” means that chemical composition is different from each other, and the phrase subsumes a state in which at least part of contained components is different, and the contents of the contained components are different even when the contained components are the same. Particularly, a compound as a main component of the channel material may be different from a compound as a main component of each layer of the separation membrane. Further, the morphology of “having different composition” also includes the case where the channel material contains at least part of components constituting the support layer and at least part of components constituting the base material.

When the permeate channel material has the composition different from that of the separation membrane, it can exhibit higher resistance to pressure than the separation membrane. Specifically, the channel material is preferably formed of a material having the shape retention higher than that of the separation membrane particularly against pressure in a direction perpendicular to a plane direction of the separation membrane, as described later. Thereby, the channel material can ensure the flow path on the permeate side even after repeated water passing or water passing under high pressure.

Further, the channel material may be disposed in such a way that separation of a fluid by the separation membrane proceeds. That is, the channel material may be disposed such that part of the separation membrane is exposed to contact the fluid and the fluid can move while contacting the separation membrane. The channel material has a different shape from the separation membrane in a face direction of the separation membrane.

As the permeate channel materials, for example, woven cloths, fabrics (net, etc.), nonwoven fabrics, porous sheets (porous film, etc.), particle-shaped materials, line-shaped materials, hemisphere-shaped materials, column-shaped materials (including circular column-shaped, prism-shaped materials, etc.) or wall-like materials, or combinations thereof can be used.

The permeate channel materials may have a continuous structure, or may have a discontinuous structure.

The “continuous” channel material is a channel material which is separated as a member having an integral structure without being separated into a plurality of parts when the channel material is peeled off from one separation membrane main body. For example, the members such as a net, tricot and a film are continuous channel materials.

On the other hand, the term “discontinuous” means a state in which the channel material is separated into a plurality of parts when the channel material is peeled off from the separation membrane main body. For convenience, any of each part separated on one separation membrane main body and the whole channel material disposed on one separation membrane main body may be both referred to as a “channel material.”

For example, when the fabric is used as the channel material, the height of the flow path is smaller than the thickness of the fabric. On the other hand, since all of the thickness of the discontinuous channel material is utilized as a height of the flow path, the discontinuous channel material can reduce flow resistance and increase the rate of water production more than the continuous structure.

Examples of the channel materials having a discontinuous structure are shown in FIGS. 6 to 9.

As shown in FIG. 6 and FIG. 11, channel materials 42 are columnar members having a nearly hemisphere-shaped upper portion, and are arranged in the form of a lattice. A shape of each channel material 43 shown in FIG. 7 is the same as that of the channel material 42, but the channel materials 43 are arranged in the form of zigzag in FIG. 7.

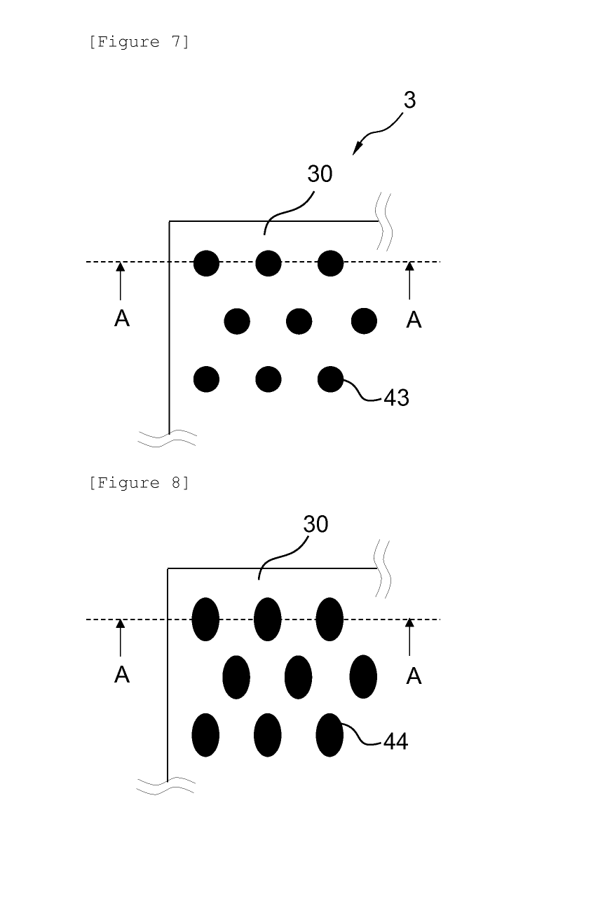

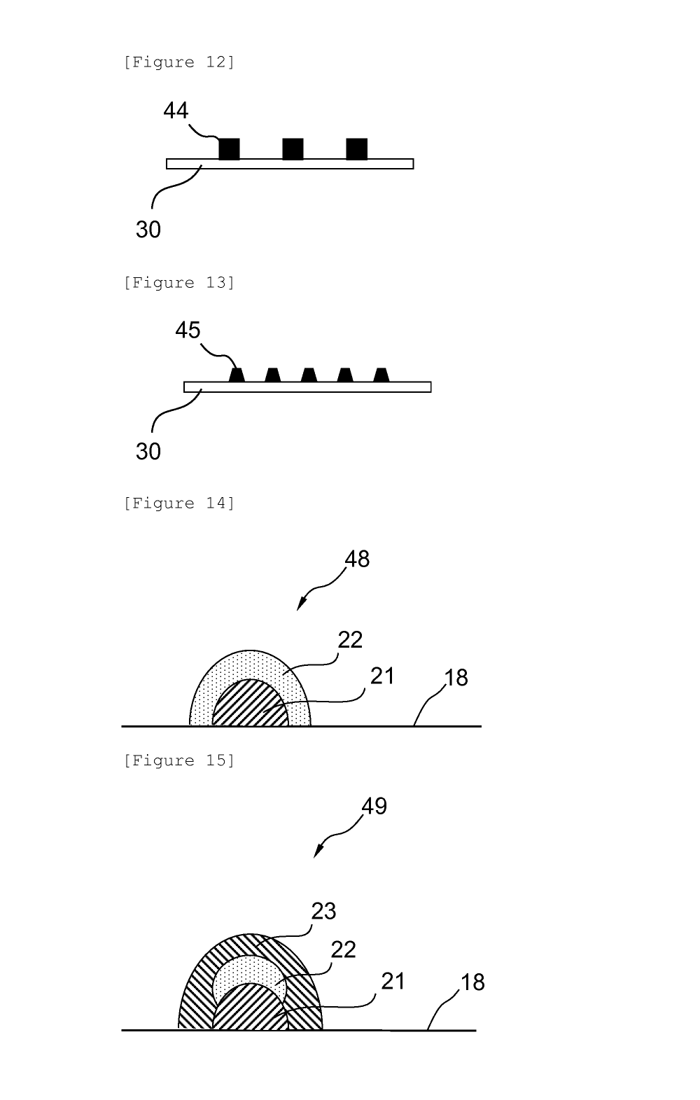

As shown in FIG. 8, channel materials 44 are elliptic columns, and are arranged in the form of zigzag. As shown in a cross-section of the channel material in FIG. 12, the channel material 44 has a flat top face and a rectangular cross-section shape.

As shown in FIG. 9, a channel material 45 is a wall-like member having a linear planar shape. The wall-like members are arranged in the form of stripes parallel to one another. As shown in FIG. 13, a cross-section of a channel material 46 in a plane perpendicular to the membrane surface has a trapezoidal shape with an upper base narrower than a lower base.

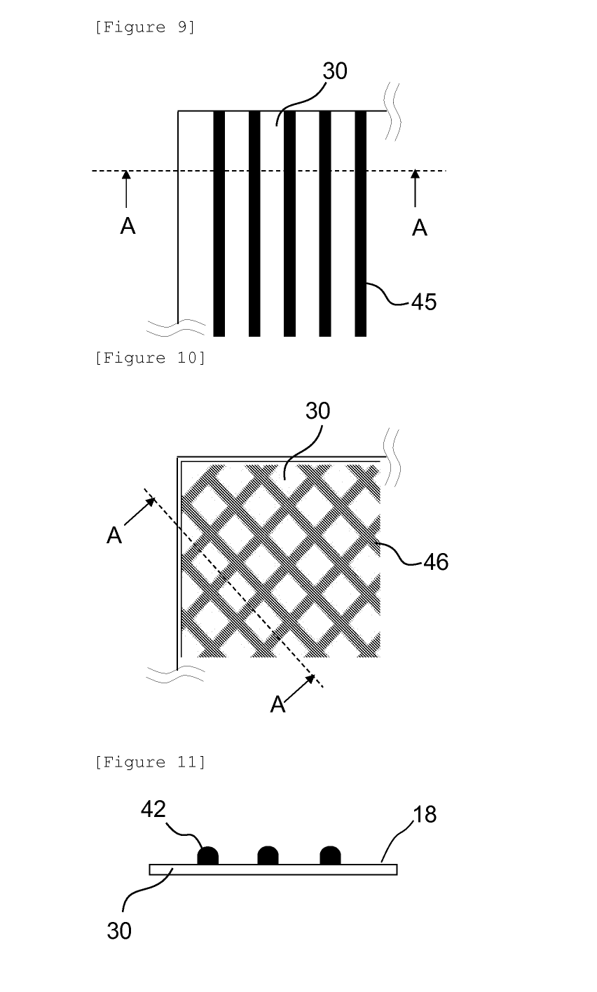

An example of a channel material having a continuous structure is shown in FIG. 10. As shown in FIG. 10, the channel material 46 is a net-like member which is continuous in a membrane surface direction.

A sectional view of the channel material taken on a dashed line indicated by arrows A shown in any of FIGS. 6 to 10, can be changed to a shape shown in any of FIGS. 11 to 13. That is, the planar shapes and the cross-section shapes, and arrangements of the channel materials which have been described as different morphologies can be combined with one another. Thus, the morphologies of the channel material which are obtained by optionally combining any of the planar shapes in FIGS. 6 to 10 with any of the cross-section shapes in FIGS. 11 to 13 also constitute the embodiments of the present invention.

Further, from the viewpoint of suppressing falling of the membrane between plural channel materials at the time of pressurized filtration, it is preferred to appropriately design a pitch (space) between adjacent channel materials to be 0.05 mm or more and 5 mm or less, and more preferably 0.1 mm or more and 2 mm or less. The pitch is the horizontal distance between the highest point of a high area and the highest point of the adjacent high area in the channel material having the height difference.

A height difference on a permeate side of the separation membrane, that is, the thickness 13 of the channel material is preferably 30 μm or more and 800 μm or less, more preferably 50 μm or more and 500 μm or less, and even more preferably 100 μm or more and 400 μm or less. When the thickness of the channel material is 800 μm or less, the number of the membrane leaves, which can be loaded in a vessel, can be increased. Further, when the thickness of the channel material is 30 μm or more, since flow resistance can be relatively reduced, good separation properties and permeation performance can be achieved.

The height difference on a permeate side of the separation membrane can be measured from a cross-section sample by using, for example, a digital microscope VHX-1000 manufactured by KEYENCE Corporation. Measurement is performed at an arbitrary point where the height difference is present, and the height difference can be determined by dividing a value obtained by summing the measured thicknesses by the number of points measured.

The projection area ratio of the channel material to the permeate side surface of the separation membrane is preferably 0.03 or more and 0.85 or less, more preferably 0.2 or more and 0.75 or less, and particularly preferably 0.3 or more and 0.6 or less. in addition, the projection area ratio is a value obtained by dividing a projection area of the channel material obtained when the separation membrane is cut out to the size of 5 cm×5 cm and the cut out piece is projected onto a plane parallel to a face direction of the separation membrane by the cut out area (25 cm²). When the projection area ratio is 0.03 or more, flow resistance of the flow path on the permeate side is kept low, and when the projection area ratio is 0.85 or less, the flow path is stably formed.

Further, the morphology of the separation membrane may be the morphology in which the channel material is disposed up to the edge of the separation membrane main body, or may be the morphology in which in the vicinity of the edge, there is an area where the channel material is not disposed. That is, when the channel material is arranged such that the flow path on the permeate side can be formed, there may be an area where the channel material is not disposed in the separation membrane main body. For example, the channel material does not need to be disposed at an area bonded to another separation membrane in the permeate side surface. Further, a region not provided with the channel material may be disposed at some locations such as the end of the separation membrane for another reason in use or production.

### [3. Method for Producing Separation Membrane]

### (3-1) Separation Membrane Main Body

The method for producing the separation membrane main body is described above, and its summary is as follows.

A resin is dissolved in a good solvent, the resulting resin solution is cast on a base material and immersed in pure water to combine a porous support layer with the base material. Thereafter, as described above, a separation functional layer is formed on the porous support layer. Moreover, as required, the separation functional layer is subjected to a chemical treatment by chlorine, acid, alkali, nitrous acid or the like in order to improve separation performance and permeation performance, and then the separation functional layer is washed for the removal of the monomer and the like to prepare a continuous sheet of the separation membrane main body.

In addition, the uneven portion may be formed on the separation membrane main body by embossing or the like before or after the chemical treatment.

### (3-2) Permeate Channel Material

A step of disposing the permeate channel materials may be conducted at any time of separation membrane production. For example, the channel material may be disposed before forming the porous support layer on the base material, or may be disposed before forming the separation functional layer and after disposing the porous support layer, or may be disposed before or after the chemical treatment after forming the separation functional layer.

Application, printing and spraying are employed for a step of forming each layer contained in the channel material. Examples of equipment used for arranging the channel material include hot-melt applicators of a nozzle type, hot-melt applicators of a spray type, hot-melt applicators of a flat nozzle type, roll coaters, extrusion type coaters, gravure printing machines, sprayers and the like.

In order to laminate two or more layers, it is possible to apply either of a method in which the layer-formation according to the above-mentioned steps is repeatedly performed two or more times, or a method in which two or more layers are formed at once by using an applicator of a co-casting type. it depends on a size and a shape of the channel material to be formed, and channel material composition to select which method is employed. Particularly, a method of simultaneously joining two or more types of channel materials by using an applicator of a co-casting type is preferred since in accordance with this method, high processing accuracy is achieved, control of each layer thickness is easy, and room for apparatus for forming layers can be reduced.

Preferred composition of the material constituting the adhesion layer and the highly elastic layer of the permeate channel materials is as described above.

When a resin is processed by heating to form the permeate channel materials, the processing temperature is not particularly limited as long as it is a temperature at which a resin can be melted and processed; however, it is preferably 250° C. or lower in view of suppressing the deterioration of membrane performance due to thermal shrink.

### [4. Method for Producing Separation Membrane Element]

### (4-1) Overview

A conventional element manufacturing apparatus can be employed for producing the separation membrane element. As a method of preparing the element, the methods described in reference literatures (JP 44-014216 B, JP 04-011928 B, JP 11-226366 A) can be used. The detail is as follows.

### (4-2) Formation of Flow Path on Feed Side

When the feed channel material is a member formed in the continuous form such as a net, the flow path on the feed side can be formed by overlaying the feed channel material on the separation membrane.

Further, the feed channel materials having a discontinuous structure or a continuous structure can be formed by applying a resin directly onto the separation membrane. When the feed channel materials are composed of feed channel materials affixed to the separation membrane main body, arranging feed channel materials may be considered as part of a method for producing a separation membrane.

Further, the flow path may be formed by providing the separation membrane main body with unevenness. Examples of a method of providing unevenness include embossing, isostatic pressing, and calendering. Conditions of embossing and a shape of embossing can be altered according to required performance of the separation membrane element. This processing of unevenness may be considered as part of a method for producing a separation membrane.

### (4-3) Laminating and Winding of Separation Membrane

An envelope-like membrane 5 is formed by folding a separation membrane so that the permeate side surface faces inward, and bonding the permeate side surfaces to each other, or by overlaying two separation membranes so that the permeate side surfaces face inward, and bonding the permeate side surfaces to each other. As described above, the envelope-like membrane is sealed at three sides thereof. Sealing can be carried out by adhesion using an adhesive, hot-melt or the like, fusion bonding using heating or laser, or the like.

The adhesive used for the formation of the envelope-like membrane preferably has a viscosity of 40 PS or more and 150 PS or less, and more preferably 50 PS or more and 120 PS or less. The occurrence of wrinkles in the separation membrane may deteriorate performance of the separation membrane element; however, when the viscosity of the adhesive is 150 PS or less, wrinkles hardly occur in winding the separation membrane around the water collecting pipe. When the viscosity of the adhesive is 40 PS or more, flow out of the adhesive from between separation membranes is suppressed, resulting in a reduction of the risk of the adhesion of the adhesive to an unnecessary portion.

The amount of the adhesive to be applied is preferably such an amount that the width of an area to which the adhesive is applied is 10 mm or more and 100 mm or less after winding the separation membrane around the water collecting pipe. This allows the separation membrane to adhere with certainty, and therefore flow of the raw fluid into the permeate side is suppressed. A relatively large effective membrane area can be secured.

As the adhesive, a urethane-based adhesive is preferable, and an adhesive prepared by mixing isocyanate as a main component and a polyol as a curing agent in proportions of from 1:1 to 1:5 is preferable in order to adjust the viscosity to the range of 40 PS or more and 150 PS or less. The viscosity of the adhesive is determined by measuring, by using Type B viscometer (JIS K 6833), the viscosity of a mixture in which the main component, the curing agent alone and a mixing ratio are previously defined.

The separation membrane to which the adhesive is applied in this way is arranged such that a closed portion of the envelope-like membrane is located on the inner side of a winding direction, and the separation membrane is wound around the water collecting pipe. Thus, the separation membrane is spirally wound.

### (4-4) Other Steps

The method for producing the separation membrane element may include winding a film, a filament and the like further around the outside of a wound body of the separation membrane formed as described above, or may include additional steps such as cutting the edges in which the edges of the separation membrane in the axial direction of the water collecting pipe are cut and aligned, attaching the end plates to the edges, and the like.

### [5. Use of Separation Membrane Element]

The separation membrane element may be processed for use as a separation membrane module through further connecting two or more separation membrane elements in series or parallel and accommodating in a pressure vessel.

Further, the separation membrane element or the separation membrane module can be used for constituting a fluid separation apparatus by combining with, for example, a pump for supplying the fluid to the separation membrane element or separation membrane module, or an apparatus which conducts pretreatment of the fluid. By using the separation apparatus, for example, the feed water can be separated into the permeate water such as drinking water and the concentrated water which does not permeate the separation membrane to obtain the desired water.

The operation pressure used in the permeation of the raw fluid through the membrane module is preferably 0.2 MPa or more and 8 MPa or less considering that though the removal rate of the components is improved with the increase of the operation pressure of the fluid separation apparatus, the energy required for the operation also increases with the pressure, and considering the retention of the feed flow path and permeate flow path of the separation membrane element. The temperature of the raw fluid is preferably 5° C. or higher and 45° C. or lower since excessively high temperature results in the reduced desalination rate and the lower temperature causes the flux of membrane permeation to decrease. Further, the operation is preferably carried out in a neutral pH range since when the pH of the raw fluid is high, there is a possibility that scales of magnesium or the like are generated in the case of feed water with high salt concentration such as sea water, and there is apprehension that the membrane deteriorates due to the operation at a high pH.

The fluid treated by the separation membrane element is not particularly limited, and examples of the feed water subjected to water treatment include a liquid mixture containing 500 mg/L or more and 100 g/L or less of TDS (total dissolved solids) such as sea water, brackish water, and drainage water. TDS generally refers to the total content of the dissolved solid content and is represented by the unit of (weight/volume) or by “weight ratio”. TDS can be calculated, by definition, from the weight of the residue when the solution filtered through a 0.45 μm filter is evaporated at a temperature of 39.5° C. to 40.5° C.; however, for more convenience, TDS can be calculated by conversion from practical salinity (S).

### EXAMPLES

Hereinafter, the present invention will be described in more detail by referring to Examples, but the present invention is by no means limited by these Examples.

### (Projection Area Ratio of Permeate Channel Material)

The separation membrane having the channel material bonded thereto was cut out to the size of 5 cm×5 cm, and the entire projection area of the channel material was measured by using a laser microscope (the magnification was selected from about 10 times to 500 times) and moving a stage of the microscope. A value obtained by dividing, by the cut out area, a projection area obtained when the channel material was projected from the permeate side or feed side of the separation membrane was taken as a projection area ratio.

### (Thickness of Permeate Channel Materials)

An average thickness was analyzed from a cross-section sample of the separation membrane provided with the channel materials bonded thereto by using a digital microscope VHX-1000 manufactured by KEYENCE Corporation. The average of the thickness was determined by measuring 30 points where the permeate channel materials having a thickness of 30 μm or more are present, and dividing a summation of the measured thicknesses by the total number of points (30 points) measured.

### (Ratio of Impregnation of Permeate Channel Materials)

The separation membrane was cut in a direction of depth together with the permeate channel materials, a cross-section was observed and 30 arbitrary impregnated portions were photographed at a magnification of 500 times by using the scanning electron microscope (Model S-900) (manufactured by HITACHI LTD.). In the photographs, the maximum thickness T2 of impregnation and the thickness T1 of the base material were measured, and the ratio of impregnation was calculated from the formula: ratio of impregnation (%)=(maximum thickness T2 of a channel material-impregnated portion in a base material/thickness T1 of the base material)×100, and an average value per one impregnated portion was determined. Hereinafter, the determined average is called as “ratio of impregnation”.

### (Pitch of Permeate Channel Materials)

A pitch of the permeate channel materials was analyzed from measurements of the backside of the separation membrane by using high precision profilometer system KS-1100 manufactured by KEYENCE Corporation. The average of the pitch was determined by measuring 30 points where the permeate channel materials having a thickness of 30 μm or more are present, and dividing a summation of the measured horizontal distances between the highest point of a high area and the highest point of the adjacent high area in the channel material by the total number of points (30 points) measured.

### (Adhesive Force)

The adhesive force is measured at an area other than an area bonded to another separation membrane (that is, the area without application of the adhesive) in the permeate side surface. To the permeate channel materials of a separation membrane sample prepared by cutting the separation membrane into a size of 25 mm in width and 200 mm in length, an aluminum foil tape (trade name: “Scotch” (registered trademark) Aluminum Foil Tape 425 manufactured by Sumitomo 3M Limited) having the same size as in the separation membrane sample was bonded by using a hand-operated roller press-bonding apparatus to prepare a test piece. Then, a bonded surface of the aluminum foil tape was peeled off by 50 mm from a width direction of the test piece (a state in which the permeate channel materials was bonded to an adhesive surface of t aluminum foil tape peeled off from the base material), and the test piece was set in the form of a letter T at a measurement length of 150 mm in a tensile tester. A tensile test was carried out at a tension rate of 50 mm/min under the conditions of 25° C. and 65% in relative humidity, and a mean value of a tensile force in a measurement length was taken as peel strength. Number of the test pieces was 10. In addition, the adhesive force was considered to be 1 N/m or more in the case where the permeate channel material remained on a base material side in peeling the bonded surface of the aluminum foil tape or in the case where part of the channel material was broken in peeling the bonded surface of the aluminum foil tape.

### (Compressive Elasticity Modulus)

A material for forming a channel material was melt formed into a columnar shape having a diameter of 10 mm and a thickness of 25 mm, and a relation between compression stress and strain was examined at a compression velocity of 10 mm/min and at 25° C. by using Tensilon Universal Material Testing Instrument (RTF-2430, manufactured by A&D Company, Limited), and an initial slope of the resulting curve was taken as a compressive elasticity modulus.

### (Desalination Rate (Removal Rate of TDS))

Seawater (TDS concentration 3.5%) adjusted to 25° C. and a pH of 6.5 was supplied to the spiral separation membrane element at an operation pressure of 5.5 MPa. An electrical conductivity of the resulting permeate water was measured by a conductance meter manufactured by TOA DENPA KOGYO KK, and thereby a practical salt content (S) was measured. The practical salt content thus obtained was considered as a salt concentration, and the removal rate of TDS was determined using the following formula.

Removal rate of TDS (%)=100×{1−(TDS concentration of the permeate water/TDS concentration of the feed water)}.

### (Rate of Water Production)

Based on the amount of permeate water in operating a separation membrane element under the same conditions as in measurement of the desalination rate, the amount (cubic meter) of permeate water per day of a separation membrane element was expressed as the rate of water production (m³/day).

### (Durability)

Seawater (TDS concentration 3.5%) adjusted to 25° C. and a pH of 6.5 was processed at an operation pressure of 5.5 MPa for 1 minute in the spiral separation membrane element, and then the operation was stopped. This operation cycle (start/stop) was repeated 2000 times, and the desalination rate and the rate of water production after the cycle test were measured.

### Example 1

On a nonwoven fabric (fiber diameter: 1 decitex, thickness: about 90 μm, air permeability: 1 cc/cm²/sec, fiber orientation degree: 40° at a surface layer on a porous support layer side, 20° at a surface layer on the side opposite to the porous support layer) made of polyester continuous fibers, a 15.0% by weight dimethylformamide (ONE) solution of polysulfone was cast at a thickness of 180 μm at room temperature (25° C.), and immediately after the casting, the nonwoven fabric was immersed in pure water and left for 5 minutes. Thereby, a roll of porous support membrane (thickness 130 μm) made of a fiber-reinforced polysulfone support membrane was prepared.

Thereafter, a polyfunctional amine aqueous solution, which was prepared such that the content of the whole polyfunctional amine in the solution was 6.5% by weight and a molar ratio between m-phenylenediamine and 1,3,5-triaminobenzene was 60:40, was applied onto the surface of cast polysulfone on the porous support membrane. After blowing nitrogen on the surface from an air nozzle to remove an excessive aqueous solution from the support membrane surface, a n-decane solution (25° C.) of polyfunctional acid chloride, which was prepared such that the content of the whole polyfunctional acid chloride in the solution was 0.17% by weight and a molar ratio between trimesic acid chloride and terephthalic acid chloride was 90:10, was applied to fully wet the surface of the membrane. Thereafter, an excessive solution was removed from the membrane by blowing air, and the membrane was washed with hot water at 70° C. to obtain a continuous sheet of a separation membrane which is a separation membrane main body.

Then, by use of a 2-layer coating hot melt applicator equipped with a comb-shaped shim having a slit width of 0.5 mm and a pitch of 1.0 mm, two layers were simultaneously applied onto a permeate side of the separation membrane at a running speed of 6 m/min under the following conditions, and thereby, channel materials having a projection area ratio of 0.55 and having an approximately trapezoidal cross-section shape and a stripe-like planar shape were formed on the separation membrane main body.

First Layer
Material: ethylene-vinyl acetate copolymer-based hot-melt resin (trade name: 701A, produced by TEX YEAR INDUSTRIES INC., compressive elasticity modulus: 0.04 GPa)
Resin temperature: 130° C.
Thickness: 30

Second Layer:
Material: polyolefin-based hot-melt resin (trade name: PHC-9275, produced by SEKISUI FULLER CO., LTD., compressive elasticity modulus: 0.18 GPa)
Resin temperature: 150° C.
Thickness: 250 μm

In addition, the first layer is a layer applied onto the separation membrane main body so as to be in contact with the separation membrane main body, and the second layer is a layer applied onto the first layer so as to overlap the first layer. Hereinafter, also in other Examples and Comparative Examples, the terms “first”, “second” and “third” represent the order of layers arranged on the separation membrane main body.

Thereafter, the separation membrane sheet was cut, and a net (thickness: 800 μm, pitch: 5 mm×5 mm) was continuously laminated, as a feed channel material, between the separation membrane sheet folded so that one side of the separation membrane sheet was opened, and a urethane-based adhesive (isocyanate:polyol=1:3) was applied onto the separation membrane sheet's both ends in an axial direction of a holed water collecting pipe, and the folded faces were overlaid to prepare 6 envelope-like membranes with a width of 930 mm so that an effective area in the separation membrane element was 8 m².

Thereafter, a predetermined portion on an opening side of the envelope-like membrane was bonded to an outer periphery of a holed water collecting pipe, and the envelope-like membrane was spirally wound to prepare a wound body. A film was wound around an outer periphery of the wound body and secured by a tape, and then after cutting the edges, the end plates were fitted on the edges and filament winding was conducted to prepare a 4-inch element.

The separation membrane element was placed in a cylindrical pressure vessel made of fiber-reinforced plastic, and the desalination rate and the rate of water production were measured by the method described above, and consequently, as shown in Table 1, with respect to initial performance, the desalination rate and the rate of water production were respectively 99.4% and 5.9 m³/day in Example 1. Further, with respect to the performance after a durability test of repeating, 2000 times, an operation cycle in which water passing was conducted for 1 minute in the same condition, the desalination rate and the rate of water production were respectively 99.6% and 5.2 m³/day, and the durability was good.

### Example 2

A separation membrane element was prepared and evaluated by the same method as in Example 1 except for changing the resin temperature of the first layer to 110° C. and changing the ratio of impregnation of the permeate channel materials to 20%.

Consequently, with respect to initial performance, the desalination rate and the rate of water production were respectively 99.4% and 6.0 m³/day. Further, with respect to the performance after a durability test of repeating, 2000 times, an operation cycle in which water passing was conducted for 1 minute at a pressure of 5.5 MPa, the desalination rate and the rate of water production were respectively 99.5% and 5.2 m³/day, and the durability was good.

### Example 3

A separation membrane element was prepared and evaluated by the same method as in Example 1 except for changing the resin temperature of the first layer to 100° C. and changing the ratio of impregnation of the permeate channel materials to 7%.

Consequently, with respect to initial performance, the desalination rate and the rate of water production were respectively 99.3% and 6.0 m³/day. Further, with respect to the performance after a durability test of repeating, 2000 times, an operation cycle in which water passing was conducted for 1 minute at a pressure of 5.5 MPa, the desalination rate and the rate of water production were respectively 99.4% and 5.1 m³/day, and the durability was good.

### Example 4

A separation membrane element was prepared and evaluated by the same method as in Example 1 except for changing the resin temperature of the first layer to 90° C. and changing the ratio of impregnation of the permeate channel materials to 3%.

Consequently, with respect to initial performance, the desalination rate and the rate of water production were respectively 99.5% and 6.1 m³/day. Further, with respect to the performance after a durability test of repeating, 2000 times, an operation cycle in which water passing was conducted for 1 minute at a pressure of 5.5 MPa, the desalination rate and the rate of water production were respectively 99.5% and 4.8 m³/day, and since the channel material was partially displaced, the reduction rate of the rate of water production was large.

### Example 5

A separation membrane element was prepared and evaluated by the same method as in Example 1 except for changing the projection area ratio of the permeate channel material to 0.80 through changing the comb-shaped shim to a comb-shaped shim having a slit width of 0.6 mm and a pitch of 1.0 mm.

Consequently, with respect to initial performance, the desalination rate and the rate of water production were respectively 99.5% and 5.4 m³/day. Further, with respect to the performance after a durability test of repeating, 2000 times, an operation cycle in which water passing was conducted for 1 minute at a pressure of 5.5 MPa, the desalination rate and the rate of water production were respectively 99.6% and 5.0 m³/day, and although the initial rate of water production was reduced a little, the durability was good.

### Example 6

A separation membrane element was prepared and evaluated by the same method as in Example 1 except for changing the projection area ratio of the permeate channel material to 0.25 through changing the comb-shaped shim to a comb-shaped shim having a slit width of 0.2 mm and a pitch of 1.0 mm. Consequently, with respect to initial performance, the desalination rate and the rate of water production were respectively 99.4% and 6.0 m³/day. Further, with respect to the performance after a durability test of repeating, 2000 times, an operation cycle in which water passing was conducted for 1 minute at a pressure of 5.5 MPa, the desalination rate and the rate of water production were respectively 99.3% and 4.0 m³/day, and since the separation membrane fell into a gap between the channel materials to partially block the flow path, the reduction rate of the rate of water production was large.

### Example 7

A separation membrane element was prepared and evaluated by the same method as in Example 1 except for changing stripe thicknesses of the first layer and the second layer to 150 μm and 100 μm, respectively.

Consequently, with respect to initial performance, the desalination rate and the rate of water production were respectively 99.3% and 5.7 m³/day. Further, with respect to the performance after a durability test of repeating, 2000 times, an operation cycle in which water passing was conducted for 1 minute at a pressure of 5.5 MPa, the desalination rate and the rate of water production were respectively 99.4% and 3.8 m³/day, and since the resin of the first layer was compressed to deform, and therefore the flow path was partially blocked, the reduction rate of the rate of water production was large.

### Example 8

A separation membrane element was prepared and evaluated by the same method as in Example 1 except for using a polypropylene resin (trade name: F219DA, produced by Prime Polymer Co., Ltd., compressive elasticity modulus: 1.3 GPa) as the second layer and changing the resin temperature to 170° C. Consequently, with respect to initial performance, the desalination rate and the rate of water production were respectively 99.3% and 5.6 m³/day. Further, with respect to the performance after a durability test of repeating, 2000 times, an operation cycle in which water passing was conducted for 1 minute at a pressure of 5.5 MPa, the desalination rate and the rate of water production were respectively 99.4% and 5.1 m³/day, and the durability was good.

### Example 9

By use of a nozzle type hot-melt applicator, a first layer was formed at a running speed of 3 m/min under the following conditions, and then a second layer was formed in turn, and thereby, dots having a projection area ratio of 0.50 and an approximately semi-elliptical cross-section shape were formed.

First Layer
Material: ethylene-vinyl acetate copolymer-based hot-melt resin (trade name: 701A, produced by TEX YEAR INDUSTRIES INC., compressive elasticity modulus: 0.04 GPa)
Resin temperature: 130° C.
Thickness: 30 μm

Second Layer:
Material: polyolefin-based hot-melt resin (trade name: PHC-9275, produced by SEKISUI FULLER CO., LTD., compressive elasticity modulus: 0.18 GPa)
Resin temperature: 150° C.
Thickness: 250 μm

Thereafter, a separation membrane element was prepared and evaluated by the same method as in Example 1.

Consequently, with respect to initial performance, the desalination rate and the rate of water production were respectively 99.3% and 5.7 m³/day. Further, with respect to the performance after a durability test of repeating, 2000 times, an operation cycle in which water passing was conducted for 1 minute at a pressure of 5.5 MPa, the desalination rate and the rate of water production were respectively 99.4% and 5.1 m³/day, and the durability was good.

### Example 10

In Example 10, a separation membrane element was prepared and evaluated by the same method as in Example 1 except for changing the base material of the separation membrane from the continuous fiber nonwoven fabric to a nonwoven fabric prepared by using a papermaking method. Consequently, since processability at the time when the permeate channel materials of the separation membrane were Mined was deteriorated, with respect to the initial performance, the desalination rate and the rate of water production were respectively 98.9% and 5.6 m³/day, and the desalination rate was slightly lowered. Further, with respect to the performance after a durability test of repeating, 2000 times, an operation cycle in which water passing was conducted for 1 minute at a pressure of 5.5 MPa, the desalination rate and the rate of water production were respectively 98.5% and 5.0 m³/day, and the desalination rate was further lowered.

### Example 11

In Example 11, by use of a 3-layer coating hot melt applicator, three layers were simultaneously applied at a running speed of 6 m/min under the following conditions, and thereby, channel materials having a projection area ratio of 0.55 to the membrane and having an approximately trapezoidal cross-section shape and a stripe-like planar shape were formed.

First Layer
Material: ethylene-vinyl acetate copolymer-based hot-melt resin (trade name: 701A, produced by TEX YEAR INDUSTRIES INC., compressive elasticity modulus: 0.04 GPa)
Resin temperature: 130° C.
Stripe thickness: 30 μm

Second Layer:
Material: polyolefin-based hot-melt resin (trade name: PHC-9275, produced by SEKISUI FULLER CO., LTD., compressive elasticity modulus: 0.18 GPa)
Resin temperature: 150° C.
Thickness: 100 μm

Third Layer:
Material: polypropylene resin (trade name: F219DA, produced by Prime Polymer Co., Ltd., compressive elasticity modulus: 1.3 GPa)
Resin temperature: 170° C.
Thickness: 150 μm

Thereafter, a separation membrane element was prepared and evaluated by the same method as in Example 1.

Consequently, with respect to initial performance, the desalination rate and the rate of water production were respectively 99.3% and 5.4 m³/day. Further, with respect to the performance after a durability test of repeating, 2000 times, an operation cycle in which water passing was conducted for 1 minute at a pressure of 5.5 MPa, the desalination rate and the rate of water production were respectively 99.4% and 5.1 m³/day, and the durability was good.

### Comparative Example 1

In Comparative Example 1, a separation membrane element was prepared and evaluated by the same method as in Example 1 except for using tricot, which is hitherto used, as the permeate channel material without being bonded to the separation membrane.

Consequently, with respect to initial performance, the desalination rate and the rate of water production were respectively 99.4% and 5.3 m³/day. Further, with respect to the performance after a durability test of repeating, 2000 times, an operation cycle in which water passing was conducted for 1 minute at a pressure of 5.5 MPa, the desalination rate and the rate of water production were respectively 99.5% and 4.8 m³/day, and since flow resistance on a permeate side was high compared with Example 1, the initial rate of water production was low.

### Comparative Example 2

By use of only one nozzle of the 2-layer coating hot melt applicator, a layer was formed at a running speed of 6 m/min under the following conditions, and thereby, stripe-like monolayer channel materials having a projection area ratio of 0.55 and an approximately trapezoidal cross-section shape were formed.
Material: ethylene-vinyl acetate copolymer-based hot-melt resin (trade name: 701A, produced by TEX YEAR INDUSTRIES INC., compressive elasticity modulus: 0.04 GPa)
Resin temperature: 130° C.
Thickness: 280 μm

Thereafter, a separation membrane element was prepared and evaluated by the same method as in Example 1.

Consequently, with respect to initial performance, the desalination rate and the rate of water production were respectively 98.9% and 3.2 m³/day. Further, with respect to the performance after a durability test of repeating, 2000 times, an operation cycle in which water passing was conducted for 1 minute at a pressure of 5.5 MPa, the desalination rate and the rate of water production were respectively 98.8% and 2.9 m³/day, and since the resin of the first layer was compressed to deform, and therefore the flow path was partially blocked, the reduction rate of the rate of water production was large.

### Comparative Example 3

By use of only one nozzle of the 2-layer coating hot melt applicator, a layer was formed at a running speed of 6 m/min under the following conditions, and thereby, stripe-like monolayer channel materials having a projection area ratio of 0.55 and an approximately trapezoidal cross-section shape were formed.
Material: polyolefin-based hot-melt resin (trade name: PHC-9275, produced by SEKISUI FULLER CO., LTD., compressive elasticity modulus: 0.18 GPa)
Resin temperature: 150° C.
Thickness: 280 μm

Thereafter, a separation membrane element was prepared and evaluated by the same method as in Example 1.

Consequently, with respect to initial performance, the desalination rate and the rate of water production were respectively 99.2% and 5.2 m³/day. Further, with respect to the performance after a durability test of repeating, 2000 times, an operation cycle in which water passing was conducted for 1 minute at a pressure of 5.5 MPa, the desalination rate and the rate of water production were respectively 98.4% and 3.6 m³/day, and since the resin of the first layer was partially peeled off from the base material to displace the flow path, the flow path was blocked, resulting in a large reduction rate of the rate of water production.

### Comparative Example 4

By use of only one nozzle of the 2-layer coating hot melt applicator, a layer was formed at a running speed of 6 m/min under the following conditions, and thereby, stripe-like monolayer channel materials having a projection area ratio of 0.55 and an approximately trapezoidal cross-section shape were formed.
Material: polypropylene resin (trade name: F219DA, produced by Prime Polymer Co., Ltd., compressive elasticity modulus: 1.3 GPa)
Resin temperature: 170° C.
Thickness: 280 μm

Thereafter, a separation membrane element was prepared and evaluated by the same method as in Example 1. Consequently, with respect to initial performance, the desalination rate and the rate of water production were respectively 99.2% and 5.4 m³/day. Further, with respect to the performance after a durability test of repeating, 2000 times, an operation cycle in which water passing was conducted for 1 minute at a pressure of 5.5 MPa, the desalination rate and the rate of water production were respectively 97.6% and 3.0 m³/day, and since the resin of the first layer was peeled off from the base material to displace the flow path, the flow path was blocked, resulting in a large reduction rate of the rate of water production.

TABLE 1

| | Permeate channel material | | | | | | | | | | | | |
|---|---|---|---|---|---|---|---|---|---|---|---|---|---|
| | | | | | Second layer | | | | | | Diameter | | |
| | First layer | | | | | Compres- | | Third layer | | | of | | Projec- |
| | Differ- | | Impregna- | Thick- | Differ- | sion | Thick- | Differ- | Thick- | | different | | tion |
| | ent | Adhesion | tion | ness | ent | modulus | ness | ent | ness | | material | Pitch | area |
| | material | (N/m) | ratio (%) | (μm) | material | (Gpa) | (μm) | material | (μm) | Shape | (mm) | (mm) | ratio |
| Example 1 | EVA | channel | 50 | 30 | Poly- | 0.18 | 250 | — | — | Stripe | 0.6 | 1.0 | 0.55 |
| | type | material | | | olefin | | | | | | | | |
| | | was broken | | | type | | | | | | | | |
| Example 2 | EVA | channel | 20 | 30 | Poly- | 0.18 | 250 | — | — | Stripe | 0.6 | 1 | 0.55 |
| | type | material | | | olefin | | | | | | | | |
| | | was broken | | | type | | | | | | | | |
| Example 3 | EVA | 20 | 7 | 30 | Poly- | 0.18 | 250 | — | — | Stripe | 0.6 | 1 | 0.55 |
| | type | | | | olefin | | | | | | | | |
| | | | | | type | | | | | | | | |
| Example 4 | EVA | 0.9 | 3 | 30 | Poly- | 0.18 | 250 | — | — | Stripe | 0.6 | 1 | 0.55 |
| | type | | | | olefin | | | | | | | | |
| | | | | | type | | | | | | | | |
| Example 5 | EVA | channel | 50 | 30 | Poly- | 0.18 | 250 | — | — | Stripe | 0.8 | 1 | 0.8 |
| | type | material | | | olefin | | | | | | | | |
| | | was broken | | | type | | | | | | | | |
| Example 6 | EVA | channel | 50 | 30 | Poly- | 0.18 | 250 | — | — | Stripe | 0.25 | 1 | 0.25 |
| | type | material | | | olefin | | | | | | | | |
| | | was broken | | | type | | | | | | | | |
| Example 7 | EVA | channel | 20 | 150 | Poly- | 0.18 | 100 | — | — | Stripe | 0.6 | 1 | 0.55 |
| | type | material | | | olefin | | | | | | | | |
| | | was broken | | | type | | | | | | | | |
| Example 8 | EVA | channel | 50 | 30 | PP | 1.3 | 250 | — | — | Stripe | 0.6 | 1 | 0.55 |
| | type | material | | | | | | | | | | | |
| | | was broken | | | | | | | | | | | |
| Example 9 | EVA | channel | 50 | 30 | Poly- | 0.18 | 250 | — | — | Dot | 1 | 0.8 | 0.5 |
| | type | material | | | olefin | | | | | geometry | | | |
| | | was broken | | | type | | | | | | | | |
| Example 10 | EVA | 15 | 15 | 30 | Poly- | 0.18 | 250 | — | — | Stripe | 0.6 | 1 | 0.55 |
| | type | | | | olefin | | | | | | | | |
| | | | | | type | | | | | | | | |
| Example 11 | EVA | channel | 15 | 30 | Poly- | 0.18 | 100 | PP | 150 | Stripe | 0.6 | 1 | 0.55 |
| | type | material | | | olefin | | | | | | | | |
| | | was broken | | | type | | | | | | | | |
| Comparative | PET | — | — | 280 | — | — | — | — | — | Tricot | 0.1 | 0.3 | 0.82 |
| Example 1 | | | | | | | | | | (knit | | | |
| | | | | | | | | | | fabric) | | | |
| Comparative | EVA | channel | 50 | 280 | — | — | — | — | — | Stripe | 0.6 | 1 | 0.55 |
| Example 2 | | material | | | | | | | | | | | |
| | | was broken | | | | | | | | | | | |
| Comparative | Poly- | 0.5 | 2 | 280 | — | — | — | — | — | Stripe | 0.6 | 1 | 0.55 |
| Example 3 | olefin | | | | | | | | | | | | |
| | type | | | | | | | | | | | | |
| Comparative | PP | 0.2 | 2 | 280 | — | — | — | — | — | Stripe | 0.6 | 1 | 0.55 |
| Example 4 | | | | | | | | | | | | | |

TABLE 2

| | | | Element | |
|---|---|---|---|---|
| | | | performance | |
| | Element | | (After | |
| | performance | | durability | |
| | (Initial) | | test) | |
| | TDS | Rate of | TDS | Rate of |
| | rejection | water | rejection | water |
| | ratio | production | ratio | production |
| | (%) | (m³/day) | (%) | (m³/day) |
| Example 1 | 99.4 | 5.9 | 99.6 | 5.2 |
| Example 2 | 99.4 | 6.0 | 99.5 | 5.2 |
| Example 3 | 99.3 | 6.0 | 99.4 | 5.1 |
| Example 4 | 99.5 | 6.1 | 99.5 | 4.8 |
| Example 5 | 99.5 | 5.4 | 99.6 | 5.0 |
| Example 6 | 99.4 | 6.0 | 99.4 | 4.0 |
| Example 7 | 99.3 | 5.7 | 99.4 | 3.8 |
| Example 8 | 99.3 | 5.6 | 99.4 | 5.1 |
| Example 9 | 99.3 | 5.7 | 99.4 | 5.1 |
| Example 10 | 98.9 | 5.6 | 98.5 | 5.0 |
| Example 11 | 99.3 | 5.4 | 99.4 | 5.1 |
| Comparative | 99.4 | 5.3 | 99.5 | 4.8 |
| Example 1 | | | | |
| Comparative | 98.9 | 3.2 | 98.8 | 2.9 |
| Example 2 | | | | |
| Comparative | 99.2 | 5.2 | 98.4 | 3.6 |
| Example 3 | | | | |
| Comparative | 99.2 | 5.4 | 97.6 | 3.0 |
| Example 4 | | | | |

### INDUSTRIAL APPLICABILITY

The separation membrane and the separation membrane element of the present invention can be particularly suitably used in desalination of brackish water and sea water.

### DESCRIPTION OF REFERENCE SIGNS

1 Separation membrane element
2 Feed channel material
3, 31, 32 Separation membrane
30, 301, 302 Separation membrane main body
4, 40 to 49 Permeate channel materials
11,15 Base material
12 Porous support layer
13,16 Separation functional layer
5 Envelope-like membrane
6 Holed water collecting pipe
7 Feed water (raw fluid)
8 Permeate water
9 Concentrated water
17 Feed side surface
18 Permeate side surface
21 Adhesion layer (first layer)
22 Other layer (second layer)
23 Other layer (third layer)

1. A separation membrane comprising: a separation membrane main body having a feed side surface and a permeate side surface, and a channel material affixed to the permeate side surface of the separation membrane main body, wherein the channel material includes two or more layers.

2. The separation membrane according to claim 1, wherein the respective layers of the channel material are bonded to one another.

3. The separation membrane according to claim 1, wherein
the channel material is affixed to the separation membrane main body with adhesive force of 1 N/m or more.

4. The separation membrane according to claim 1, wherein the channel material has an adhesion layer to be bonded to the separation membrane main body, and a highly elastic layer laminated on the adhesion layer, and the compressive elasticity modulus of the highly elastic layer is 0.1 GPa or more and 5.0 GPa or less.

5. The separation membrane according to claim 1, wherein the channel material is formed of a thermoplastic resin.

6. The separation membrane according to claim 1, wherein the separation membrane comprises a base material; a porous support layer formed on the base material; and a separation functional layer formed on the porous support layer.

7. The separation membrane according to claim 1, wherein the base material is a continuous fiber nonwoven fabric.

8. A separation membrane element including the separation membrane according to claim 1.

9. The separation membrane according to claim 2, wherein the channel material is affixed to the separation membrane main body with adhesive force of 1 N/m or more.

10. The separation membrane according to claim 2, wherein the channel material has an adhesion layer to be bonded to the separation membrane main body, and a highly elastic layer laminated on the adhesion layer, and the compressive elasticity modulus of the highly elastic layer is 0.1 GPa or more and 5.0 GPa or less.

11. The separation membrane according to claim 3, wherein the channel material has an adhesion layer to be bonded to the separation membrane main body, and a highly elastic layer laminated on the adhesion layer, and the compressive elasticity modulus of the highly elastic layer is 0.1 GPa or more and 5.0 GPa or less.

12. The separation membrane according to claim 2, wherein the channel material is formed of a thermoplastic resin.

13. The separation membrane according to claim 3, wherein the channel material is formed of a thermoplastic resin.

14. The separation membrane according to claim 4, wherein the channel material is formed of a thermoplastic resin.

15. The separation membrane according to claim 2, wherein the separation membrane comprises a base material; a porous support layer formed on the base material; and a separation functional layer formed on the porous support layer.

16. The separation membrane according to claim 3, wherein the separation membrane comprises a base material; a porous support layer formed on the base material; and a separation functional layer formed on the porous support layer.

17. The separation membrane according to claim 4, wherein the separation membrane comprises a base material; a porous support layer formed on the base material; and a separation functional layer formed on the porous support layer.

18. The separation membrane according to claim 5, wherein the separation membrane comprises a base material; a porous support layer formed on the base material; and a separation functional layer formed on the porous support layer.

19. The separation membrane according to claim 2, wherein the base material is a continuous fiber nonwoven fabric.

20. The separation membrane according to claim 3, wherein the base material is a continuous fiber nonwoven fabric.
